(19) United States
(12) Patent Application Publication
(10) Pub. No.: US 2025/0311080 A1
(43) Pub. Date: Oct. 2, 2025

(54) PLASMA FORMING DEVICE

(71) Applicant: JUBILEE INTERNATIONAL BIOMEDICAL CO., LTD., Taipei City (TW)

(72) Inventors: Hui-Fang LI, Taipei City (TW); Han-Chang CHOU, Taipei City (TW); Bo-Yi YU, Taipei City (TW); Xin-Qi CHEN, Taipei City (TW); Chih-Hsien LIU, Taipei City (TW); Che-Wei CHANG, Taipei City (TW); Sheng-Ya LIN, Taipei City (TW)

(73) Assignee: JUBILEE INTERNATIONAL BIOMEDICAL CO., LTD., Taipei City (TW)

(21) Appl. No.: 19/093,770

(22) Filed: Mar. 28, 2025

(30) Foreign Application Priority Data
Mar. 29, 2024 (TW) 113112087

(51) Int. Cl. H05H 1/24

(52) U.S. Cl. CPC H05H 1/2431

(57) ABSTRACT

A plasma forming device includes a housing unit and an electrode unit. The housing unit includes an inner housing having a first gas inlet, a reaction channel that spatially communicates with the first gas inlet, and an inner housing opening that spatially communicates with the reaction channel. The first gas inlet is adapted for entrance of a first gas therethrough into the reaction channel. The electrode unit includes an inner dielectric tube extending in the reaction channel, an inner electrode sleeved on the inner dielectric tube, an outer dielectric tube disposed in the reaction channel, and surrounding the inner electrode and a portion of the inner dielectric tube, and an outer electrode sleeved on the outer dielectric tube and aligned with the inner electrode. The inner electrode and the outer dielectric tube cooperatively define a curved passage that is adapted for passage of the first gas therethrough.

### CROSS-REFERENCE TO RELATED APPLICATIONS

This application claims priority to Taiwanese Invention Patent Application No. 113112087, filed on Mar. 29, 2024, the entire disclosure of which is incorporated by reference herein.

### FIELD

The disclosure relates to a plasma forming device, and more particularly to a plasma forming device having a high efficiency.

### BACKGROUND

A conventional plasma forming device forms plasma by subjecting a gas to an electromagnetic field to induce ionization of particles or molecules in the gas. Since plasma has wide ranges of temperature and density, the range of its use is also wide. Plasma can be applied in academic, technological and industrial fields, such as plasma etching in semiconductor manufacturing, or plasma welding and cutting; it can also be used in air purifiers or fluorescent lights. Plasma can even be used in medical treatment, such as treatment for onychomycosis. However, for conventional plasma generated by currently available plasma forming devices, the ionization degree of molecules are insufficient. Hence, there is room for improvement.

### SUMMARY

Therefore, an object of the disclosure is to provide a plasma forming device that can alleviate at least one of the drawbacks of the prior art.

According to the disclosure, the plasma forming device includes a housing unit and an electrode unit. The housing unit includes an inner housing. The inner housing has a first gas inlet, a reaction channel that spatially communicates with the first gas inlet, and an inner housing opening that spatially communicates with the reaction channel. The first gas inlet is adapted for entrance of a first gas therethrough into the reaction channel. The electrode unit extends through the inner housing, and includes an inner dielectric tube, an inner electrode, an outer dielectric tube, and an outer electrode. The inner dielectric tube extends in the reaction channel. The inner electrode is sleeved on the inner dielectric tube. The outer dielectric tube is disposed in the reaction channel, and surrounds the inner electrode and a portion of the inner dielectric tube. The outer electrode is sleeved on the outer dielectric tube and aligned with the inner electrode. The inner electrode and the outer dielectric tube cooperatively define a curved passage that is adapted for passage of the first gas therethrough.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of a plasma forming device according to the disclosure.

FIG. 2 is a perspective view of a housing unit and an electrode unit of the embodiment.

FIG. 3 is a partially exploded perspective view of the housing unit and the electrode unit.

FIG. 4 is a sectional view taken along line IV-IV in FIG. 2.

FIG. 5 is a sectional view taken along line V-V in FIG. 2.

FIG. 6 is an exploded perspective view of the electrode unit.

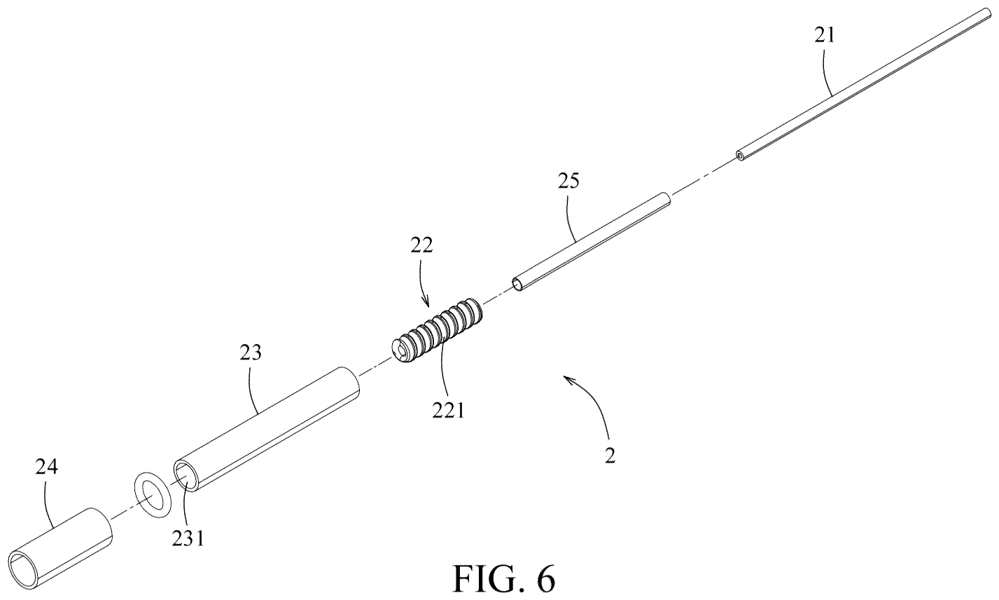

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (c.g., rotated 90 degrees or at other orientations) and the spatially relative terms used herein may be interpreted accordingly.

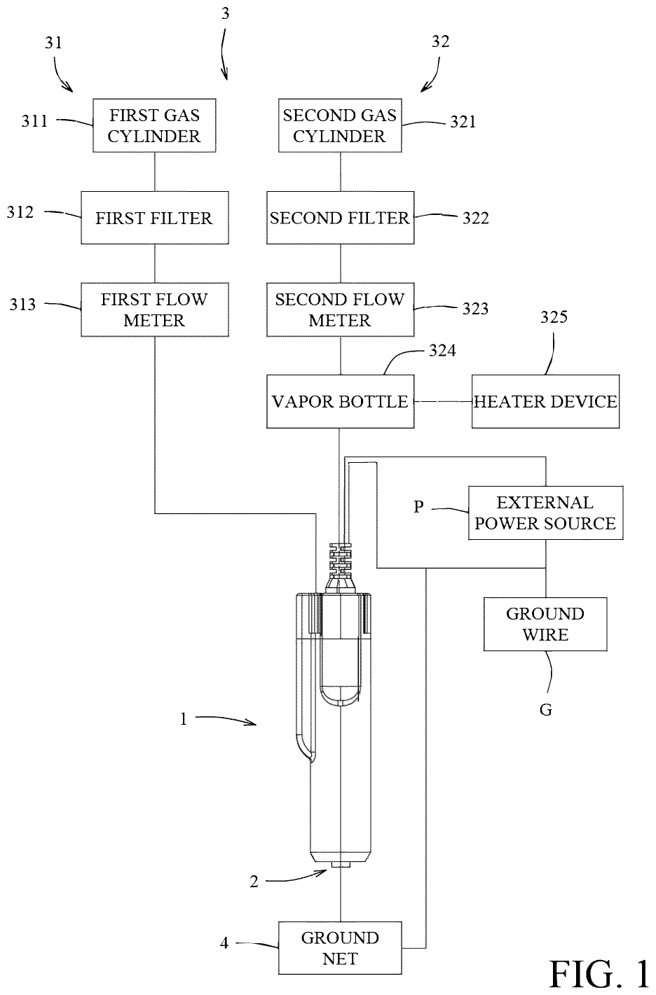

Referring to FIG. 1, an embodiment of a plasma forming device according to the disclosure is adapted for forming cold plasma. Cold plasma, with its temperature ranging from 25 to 30 degrees Celsius, has a lower temperature compared to thermal plasma (also known as hot plasma). Since the temperature of cold plasma is close to room temperature, cold plasma is safe for human contact and can be used in biomedical fields. Furthermore, cold plasma produces reactive species such as reactive oxygen and nitrogen species (RONS). Cold plasma formed by the plasma forming device of the disclosure produces RONS that have sterilizing and antibacterial properties, and can be used in medical treatment such as treatment for onychomycosis. The plasma forming device includes a housing unit 1, an electrode unit 2, and a gas processor module 3.

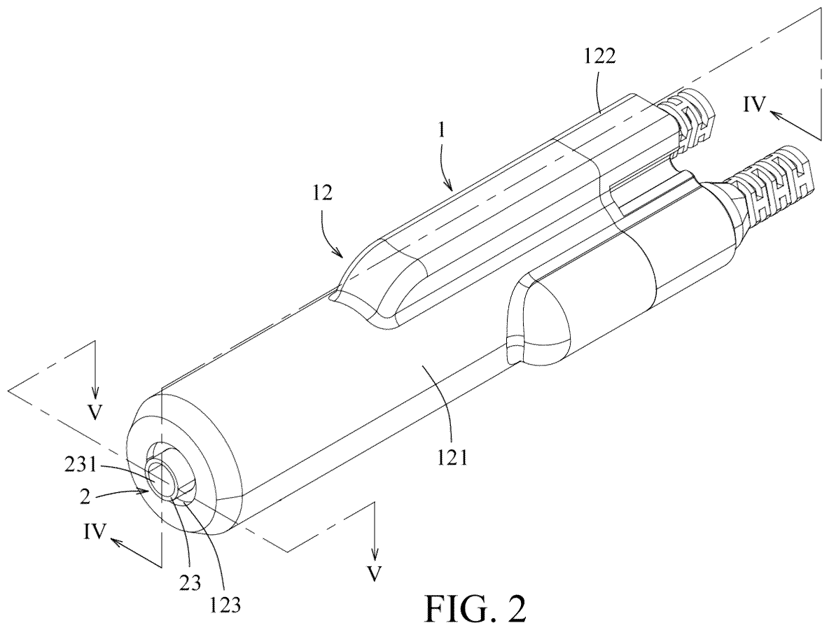

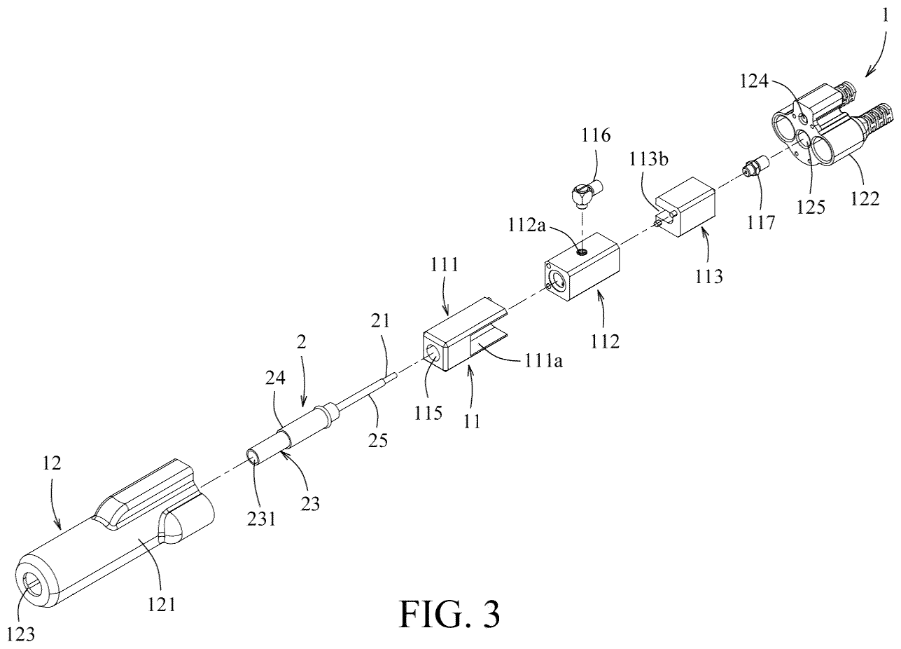

Referring to FIGS. 2 to 4, the housing unit 1 includes an inner housing 11 and an outer housing 12 surrounding the inner housing 11. The inner housing 11 includes a front housing member 111, an intermediate housing member 112 that is connected to the front housing member 111, a rear housing member 113 that is connected to the intermediate housing member 112, a first tube connector member 116 that is connected to the intermediate housing member 112, and a second tube connector member 117 that is connected to the rear housing member 113. The front housing member 111 is formed with an inner housing opening 115 at an end thereof, and is further formed with a front housing opening 11la. The intermediate housing member 112 is connected to an end of the front housing member 111 opposite to the inner housing opening 115. The front housing member 111 and the intermediate housing member 112 cooperatively define the reaction channel 114 that spatially communicates with the inner housing opening 115. The intermediate housing member 112 is formed with a first gas inlet 112a that spatially communicates with the reaction channel 114 and that is adapted for entrance of a first gas therethrough into the reaction channel 114. The first gas inlet 112a is a threaded hole. Specifically, the first tube connector member 116 threadedly engages the first gas inlet 112a, so that the first gas passes through the first tube connector member 116 to enter the reaction channel 114. The rear housing member 113 is formed with a second gas inlet 113a and is further formed with a rear housing opening 113b. Specifically, the second gas inlet 113a is formed in an end of the rear housing member 113 opposite to the intermediate housing member 112, and the rear housing opening 113b is formed in a side of the rear housing member 113. The second gas inlet 113a is a threaded hole, and is adapted for entrance of a second gas therethrough. Specifically, the second tube connector member 117 threadedly engages the second gas inlet 113a.

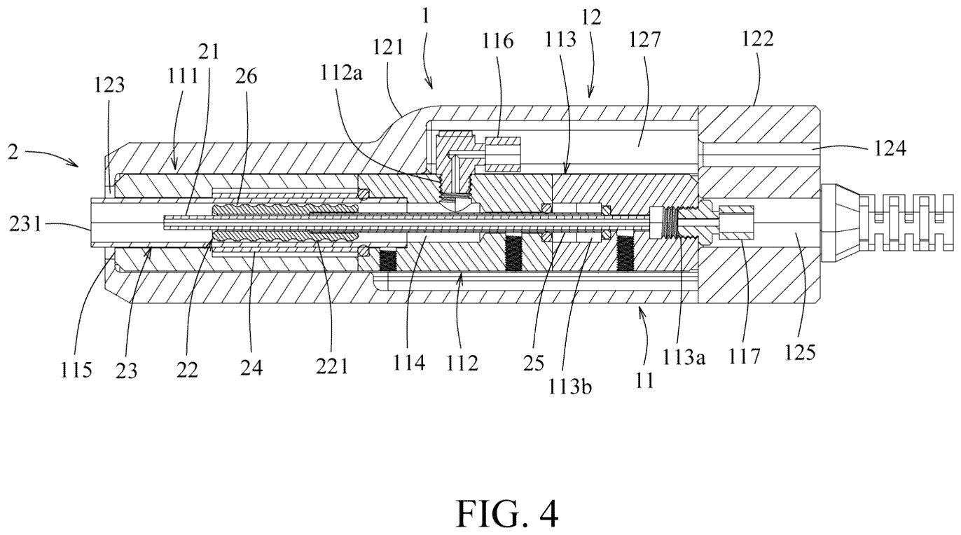

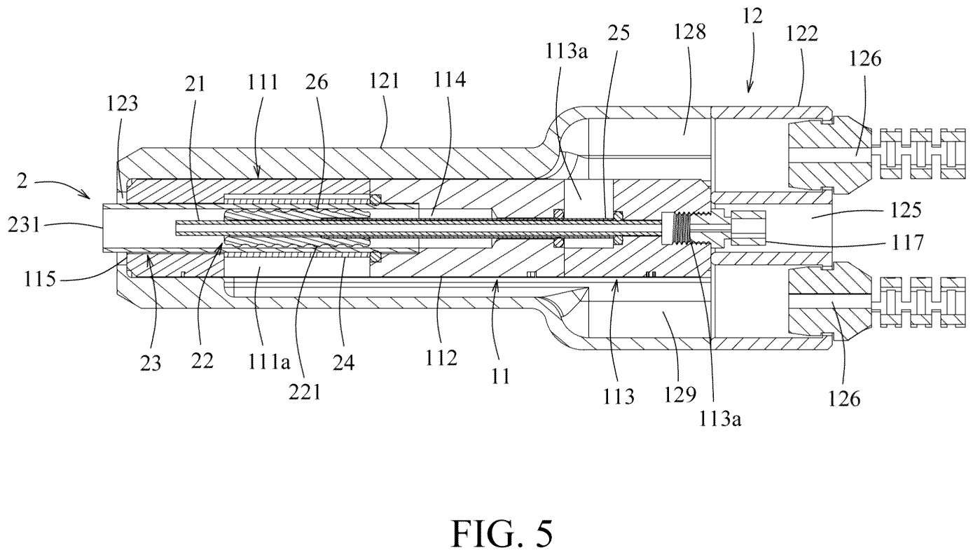

Referring to FIGS. 2, 3 and 5, the outer housing 12 includes a front portion 121, and a rear portion 122 connected to the front portion 121. The front portion 121 is disposed around the inner housing 11, and has a front portion opening 123. The front portion opening 123 is formed in an end of the front portion 121 opposite to the rear portion 122. The rear portion 122 has a first rear opening 124, a second rear opening 125 that is aligned with the second gas inlet 113a, and two guide holes 126. The front portion 121 defines a first passage 127 (see FIG. 4) spatially communicating with the first gas inlet 112a and the first rear opening 124. The front portion 121 and the rear portion 122 of the outer housing 12 cooperatively define a right passage 128 interconnecting one of the guide holes 126 and the rear housing opening 113b of the rear housing member 113, and a left passage 129 interconnecting the other one of the guide holes 126 and the front housing opening 111a of the front housing member 111.

Referring to FIGS. 1, 3 and 5, the electrode unit 2 extends in the inner housing 11, and includes an inner dielectric tube 21 extending from the front housing member 111, through the intermediate housing member 112, into the rear housing member 113, and extending in the reaction channel 114, an inner electrode 22 sleeved on the inner dielectric tube 21, an outer dielectric tube 23 disposed in the reaction channel 114, and surrounding the inner electrode 22 and a portion of the inner dielectric tube 21, an outer electrode 24 sleeved on the outer dielectric tube 23 and aligned with the inner electrode 22, and a conductive tube 25 sleeved on the inner dielectric tube 21, connected to the inner electrode 22, and extending into the rear housing member 113. The inner electrode 22 and the outer dielectric tube 23 cooperatively define a curved passage 26 that is adapted for passage of the first gas therethrough. Specifically, the inner electrode 22 is tubular, and has an outer surface formed with an external thread 221. The external thread 221 and the outer dielectric tube 23 cooperatively define the curved passage 26. In this embodiment, the curved passage 26 has a helical shape, but may have other shapes in other embodiments. The inner dielectric tube 21 is made of quartz, and has an open end that is proximate to the inner housing opening 115 and that is disposed in the outer dielectric tube 23. The second gas inlet 113a of the rear housing member 113 spatially communicates with the inner dielectric tube 21, such that the second gas passes through the second tube connector member 117, which engages the second gas inlet 113a, to enter the inner dielectric tube 21. The outer dielectric tube 23 is made of quartz, and has an end that protrudes outwardly from the inner housing opening 115 and the front portion opening 123, and that is formed with an outer dielectric tube opening 231. In this embodiment, the outer dielectric tube opening 231 is adapted for contacting skin. The front housing opening 11la is adapted for extension of a wire (not shown) therethrough, and the rear housing opening 113b is adapted for extension of another wire (not shown) therethrough, so that the conductive tube 25 and the outer electrode 24 are adapted for, respectively via the wire and the another wire, connecting an external power source (P). The two guide holes 126 are adapted for the wire and the another wire to extend therethrough, respectively. The right passage 128 is adapted for passage of the wire to be connected to the conductive tube 25, and the left passage 129 is adapted for passage of the another wire to be connected to the outer electrode 24. In other words, the wire extends through the respective guide hole 126, the right passage 128 and the rear housing opening 113b to be electrically connected to the conductive tube 25. Specifically, the conductive tube 25 is electrically connected to the inner electrode 22. The another wire extends through the respective guide hole 126, the left passage 129 and the front housing opening 11la to be electrically connected to the outer electrode 24. The another wire is connected to a ground wire (G) and a ground net 4 (sec FIG. 1). The front portion opening 123 is adapted to have the ground net 4 be disposed thereonto. The outer electrode 24 is adapted for connection with the ground net 4. The ground net 4 prevents electrostatic discharge and increases safety. When a gas is converted into plasma, electrostatic charges may be generated, especially in high energy density plasmas. The electrostatic charges in the plasma forming device accumulate in the curved passage 26 where the first gas flows, which causes an imbalance of electric charges, and the imbalance may result in electrostatic discharge.

The ground net 4 allows the electrostatic charges in the plasma forming device to move to the ground wire (G), thereby reducing the chance of electrostatic discharge and ensuring the safety of the user and the plasma forming device.

Referring to FIG. 1, the gas processor module 3 includes a first gas processor unit 31 connected to the first gas inlet 112a, and a second gas processor unit 32 connected to the second gas inlet 113a. The first gas processor unit 31 includes a first gas cylinder 311, a first filter 312 that is connected to the first gas cylinder 311, and a first flow meter 313 that is connected to the first gas cylinder 311 and spatially communicates with the first gas inlet 112a. The first gas cylinder 311 is adapted for providing the first gas. The first filter 312 is adapted for filtering the first gas. The first flow meter 313 is adapted for controlling the flow of the first gas. The first gas enters the first gas inlet 112a via the first tube connector member 116. The first gas is one of helium gas, argon gas, nitrogen gas, and a combination thereof. The second gas processor unit 32 includes a second gas cylinder 321, a second filter 322 that is connected to the second gas cylinder 321, a second flow meter 323 that is connected to the second gas cylinder 321, a vapor bottle 324 that is connected to the second gas cylinder 321, that spatially communicates with the second gas inlet 113a, and that is adapted for accommodating water, and a heater device 325. The second gas cylinder 321 is adapted for providing the second gas. The second gas enters the second gas inlet 113a via the second tube connector member 117. The heater device 325 is adapted for heating the water in the vapor bottle 324 to vaporize the water. The second gas is one of oxygen, water vapor, medicine and a combination thereof. An operation process of the vapor bottle 324 is as follows. The heater device 325 heats the water in the vapor bottle 324, and the water is vaporized and mixed with the second gas to increase the concentration of OH-ions in the second gas.

Referring to FIGS. 1, 4 and 5, an operation method of the plasma forming device is as follows. The first gas flows into and enters the reaction channel 114 via the first gas inlet 112a, and flows into the curved passage 26 where the first gas is subjected to the electromagnetic field between the inner electrode 22 and the outer electrode 24 that ionizes the first gas, converting the first gas into plasma. The plasma then mixes and reacts with the second gas flowing out of the open end of the inner dielectric tube 21, and then flows out of the plasma forming device from the outer dielectric tube opening 231. By virtue of the configuration of the curved passage 26, the time needed for the first gas to pass through the electromagnetic field between the inner electrode 22 and the outer electrode 24 is increased, which extends the time the first gas is subjected to the electromagnetic field and increases ionization of the first gas. The composition of the second gas influences the effect of the product of the second gas and the plasma. For example, when the second gas is water vapor, and the first gas is argon gas, after the second gas mixes with the plasma formed from the first gas, hydroxyl groups are formed after the water vapor of the second gas mixes with the argon gas, which has moisturizing effects on skin treated by the plasma. The oxygen and the water vapor of the second gas mix together to form hydrogen peroxide (H2O2), which has antibacterial effects. In this embodiment, the medicine is medicine for onychomycosis.

In conclusion, by virtue of the configuration of the curved passage 26, the time needed for the first gas to pass through the electromagnetic field between the inner electrode 22 and the outer electrode 24 is increased, which extends the time the first gas is subjected to the electromagnetic field and increases ionization of the first gas. In other words, more of the molecules or particles in the first gas can be ionized, which increases density and activeness of the plasma, so that the ions in the plasma react faster with the second gas, thereby increasing the efficiency of the plasma in medical treatment processes. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A plasma forming device comprising:
a housing unit that includes an inner housing, said inner housing having a first gas inlet, a reaction channel that spatially communicates with said first gas inlet, and an inner housing opening that spatially communicates with said reaction channel, said first gas inlet being adapted for entrance of a first gas therethrough into said reaction channel; and
an electrode unit that extends in said inner housing, and that includes
an inner dielectric tube extending through said reaction channel,
an inner electrode sleeved on said inner dielectric tube,
an outer dielectric tube disposed in said reaction channel, and surrounding said inner electrode and a portion of said inner dielectric tube, and
an outer electrode sleeved on said outer dielectric tube and aligned with said inner electrode, said inner electrode and said outer dielectric tube cooperatively defining a curved passage that is adapted for passage of the first gas therethrough.

2. The plasma forming device as claimed in claim 1, wherein said curved passage has a helical shape.

3. The plasma forming device as claimed in claim 1, wherein said inner electrode is tubular, and has an outer surface formed with an external thread, said external thread and said outer dielectric tube cooperatively defining said curved passage.

4. The plasma forming device as claimed in claim 1, wherein:
said inner housing further has a second gas inlet that spatially communicates with said inner dielectric tube;
said inner dielectric tube has an open end that is proximate to said inner housing opening and that is disposed in said outer dielectric tube; and
said second gas inlet is adapted for entrance of a second gas therethrough into said inner dielectric tube.

5. The plasma forming device as claimed in claim 4, wherein:
said inner housing includes
a front housing member that is formed with said inner housing opening,
an intermediate housing member that is connected to an end of said front housing member opposite to said inner housing opening, and that is formed with said first gas inlet, and
a rear housing member that is connected to said intermediate housing member, and that is formed with said second gas inlet; and
said front housing member and said intermediate housing member cooperatively define said reaction channel.

6. The plasma forming device as claimed in claim 5, wherein:
said inner dielectric tube extends from said front housing member, through said intermediate housing member, into said rear housing member;
said electrode unit further includes a conductive tube that is sleeved on said inner dielectric tube, that is connected to said inner electrode, and that extends into said rear housing member; and
said front housing member is further formed with a front housing opening that is adapted for extension of a wire therethrough, and said rear housing member is further formed with a rear housing opening that is adapted for extension of another wire therethrough, so that said conductive tube and said outer electrode are adapted for, respectively via the wire and the another wire, connecting an external power source.

7. The plasma forming device as claimed in claim 6, wherein:
said housing unit further includes an outer housing that includes
a front portion disposed around said inner housing, and
a rear portion connected to said front portion and having
a first rear opening,
a second rear opening that is aligned with said second gas inlet, and
two guide holes that are adapted for the wire and the another wire to extend therethrough, respectively;
said front portion defines a first passage spatially communicating with said first gas inlet and said first rear opening;
said front portion and said rear portion of said outer housing cooperatively define a right passage and a left passage;
said right passage interconnects one of said guide holes and said rear housing opening of said rear housing member, and is adapted for passage of the wire to be connected to said conductive tube; and
said left passage interconnects another one of said guide holes and said front housing opening of said front housing member, and is adapted for passage of the another wire to be connected to said outer electrode.

8. The plasma forming device as claimed in claim 7, further comprising a gas processor module that includes a first gas processor unit connected to said first gas inlet, and a second gas processor unit connected to said second gas inlet, said first gas processor unit including a first gas cylinder that is adapted for providing the first gas, said second gas processor unit including a second gas cylinder that is adapted for providing the second gas, a vapor bottle that is connected to said second gas cylinder, that spatially communicates with said second gas inlet, and that is adapted for accommodating water, and a heater device that is adapted for heating the water in said vapor bottle to vaporize the water.
